(19) United States
(12) Patent Application Publication
(10) Pub. No.: US 2020/0150648 A1
(43) Pub. Date: May 14, 2020

(54) VEHICLE CONTROL APPARATUS

(71) Applicant: HITACHI AUTOMOTIVE SYSTEMS, LTD., Hitachinaka-shi, Ibaraki (JP)

(72) Inventors: Yuki HORITA, Tokyo (JP); Yuji FUKUSHIMA, Hitachinaka-shi (JP); Fumio NARISAWA, Hitachinaka-shi (JP); Masato HAYASHI, Hitachinaka-shi (JP)

(21) Appl. No.: 16/629,661

(22) PCT Filed: Jun. 14, 2018
(86) PCT No.: PCT/JP2018/022682

§ 371 Date: Jan. 9, 2020

(30) Foreign Application Priority Data
Jul. 25, 2017 (JP) 2017-143738

(51) Int. Cl. G05D 1/00; G01C 21/36; H04W 4/40

(52) U.S. Cl. CPC G05D 1/0027; G05D 2201/0213; H04W 4/40; G01C 21/3605

(57) ABSTRACT

Provided is a vehicle control apparatus configured to be communicably connected to an external apparatus. The vehicle control apparatus includes: a communication control unit configured to control data transmission to and reception from the external apparatus; a data management unit configured to manage object data; one or more functional components configured to perform a predetermined calculation by using object data acquired from the data management unit or the communication control unit, and to output output object data acquired by the predetermined calculation to the data management unit; and a storage unit configured to store setting information in which information on a writing destination of the output object data is stored for each of the functional components and to store object data. The data management unit is configured to control the writing destination of the output object data based on the setting information.

### TECHNICAL FIELD

The present invention relates to a vehicle control apparatus.

### BACKGROUND ART

In a control system including a plurality of embedded devices connected via a network, a technology has been proposed which can achieve a configuration change of application software (hereinafter, an application) without modifying a program. The technology is implemented by a middleware that operates in common on each embedded device by controlling, based on setting information, a storage destination of data used for calculation performed by an application. A configuration change of an application includes a “static configuration change” performed when the embedded device is in a non-execution state (during design or when the device is stopped), and a “dynamic configuration change” performed when the embedded device is in an execution state. Examples of the static configuration change include a case where the application is applied to a system having a different device configuration (for example, loading the application onto a different vehicle type). On the other hand, examples in which the dynamic configuration change is necessary include a fail-operational system that maintains the control system by, when a certain embedded device on the control system has a malfunction, starting up an application that operates on the embedded device having the malfunction on another embedded device.

For example, PTL 1 discloses a communication apparatus including a communication unit configured to communicate with another communication apparatus. The communication apparatus includes: a unit configured to execute a plurality of different application programs; a unit configured to execute a platform program in common with said another communication apparatus; a storage unit configured to store data; a unit configured to perform, via processing of the platform program, data exchange between the storage unit and the application programs, data transmission to and reception from the other communication apparatus, and storage of data received from said another communication apparatus by the communication unit to the storage unit, in common with the other communication apparatus; and a generation unit configured to generate, via processing of the platform program, another piece of data by using one or more pieces of the data stored in the storage unit. The generation unit is configured to transmit generated data to said another communication apparatus with the communication unit.

### PRIOR ART LITERATURE

### Patent Literature

PTL 1: Japanese Patent Application Number 2008-153271

### SUMMARY OF INVENTION

### Technical Problem

In the invention described in PTL 1, a storage capacity of each embedded device and a network bandwidth are wastefully consumed.

### Solution to Problem

An aspect of the invention provides a vehicle control apparatus configured to be communicably connected to an external apparatus. The vehicle control apparatus includes: a communication control unit configured to control data transmission to and reception from the external apparatus; a data management unit configured to manage object data; one or more functional components configured to perform a predetermined calculation by using object data acquired from the data management unit or the communication control unit, and to output output object data which is object data acquired by the predetermined calculation to the data management unit; and a storage unit configured to store setting information in which information on a writing destination of the output object data is stored for each of the functional components and to store the object data. The data management unit is configured to control the writing destination of the output object data based on the setting information.

### Advantageous Effect

According to the invention, unnecessary data storage and communication can be reduced.

### BRIEF DESCRIPTION OF DRAWINGS

FIG. 1 is a functional block diagram of a vehicle system 1.

FIG. 2 is a diagram showing an example of a setting information data group 141.

FIG. 3 is a table showing an example of an object data group 142.

FIG. 4(a) is a table showing an example of a setting change data group 143a, and FIG. 4(b) is a table showing an example of a setting change data group 143b.

FIG. 5(a) is a table showing an example of a setting information table A, and FIG. 5(b) is a table showing an example of a setting information table B.

FIG. 6(a) is a table showing an example of a module list M1, and FIG. 6(b) is a table showing an example of a module list M2.

FIG. 7 is a diagram showing an example of an API group of an object data operation interface 125.

FIG. 8 is a flowchart showing a periodic processing of an execution control unit 14.

FIG. 9 is a flowchart showing an object data update processing.

FIG. 10 is a flowchart showing a completion notification reception processing.

FIG. 11 is a table showing an example of an object data update operation request message.

FIG. 12 is a diagram showing an operation example of a dynamic configuration change.

FIG. 13 is a table showing an example of a setting change data group 143p according to a first modification.

FIG. 14 is a functional block diagram of a development system 1a according to a second embodiment.

FIG. 15 is a functional block diagram of an operation apparatus 6.

FIG. 16 is a table showing an example of the setting information data group 141a of a vehicle control apparatus 2 according to the second embodiment.

FIG. 17 is a functional block diagram of the development system 1a for debugging a map fusion calculation unit 132.

FIG. 18 is a functional block diagram of the operation apparatus 6 for debugging the map fusion calculation unit 132.

FIG. 19 is a table showing an example of the setting information data group 141a in FIG. 17.

### DESCRIPTION OF EMBODIMENTS

### First Embodiment

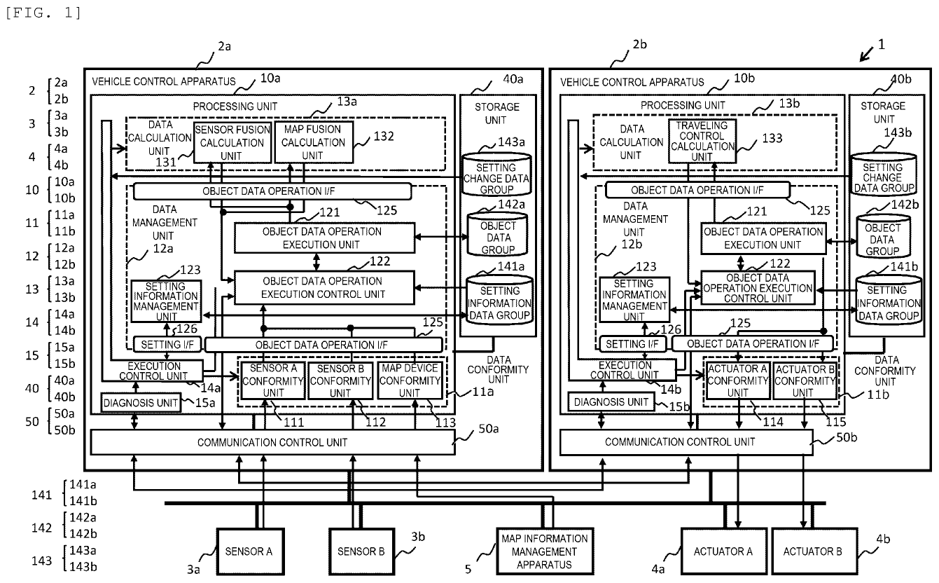

Hereinafter, a first embodiment of a vehicle control apparatus will be described with reference to FIGS. 1 to 12.

### (Configuration of Vehicle System)

FIG. 1 is a functional block diagram showing an example of a configuration of a vehicle system 1 including the vehicle control apparatus. The vehicle system 1 is a system mounted on a vehicle and for performing appropriate driving assistance or traveling control after recognizing a state of a traveling road around the vehicle or an obstacle such as a surrounding vehicle. As shown in FIG. 1, the vehicle system 1 includes a vehicle control apparatus 2a, a vehicle control apparatus 2b, a sensor group 3, an actuator group 4, and a map information management apparatus 5. The sensor group 3 includes a sensor A indicated by a reference numeral 3a and a sensor B indicated by a reference numeral 3b. However, the sensor group 3 may include three or more sensors. The actuator group 4 includes an actuator A indicated by a reference numeral 4a and an actuator B indicated by a reference numeral 4b. However, the actuator group 4 may include three or more actuators. Hereinafter, the vehicle control apparatus 2a and the vehicle control apparatus 2b are also collectively referred to as a “vehicle control apparatus 2”.

The vehicle control apparatus 2 is, for example, an electronic control unit (ECU) mounted on the vehicle. The vehicle control apparatus 2a includes a processing unit 10a, a storage unit 40a, and a communication control unit 50a. The vehicle control apparatus 2b includes a processing unit 10b, a storage unit 40b, and a communication control unit 50b. Hereinafter, the processing unit 10a and the processing unit 10b are also collectively referred to as a “processing unit 10”, the storage unit 40a and the storage unit 40b are also collectively referred to as a “storage unit 40”, and the communication control unit 50a and the communication control unit 50b are also collectively referred to as a “communication control unit 50”.

In the vehicle system 1, a calculation necessary for automatic driving is executed by the vehicle control apparatus 2a and the vehicle control apparatus 2b. That is, automatic driving is implemented by a cooperative operation between the vehicle control apparatus 2a and the vehicle control apparatus 2b. However, a function implemented by the vehicle system 1 in the present embodiment is an example, and a function other than automatic driving may be implemented by the vehicle system 1.

The processing unit 10 includes, for example, a central processing unit (CPU) or a graphics processing unit (GPU). The processing unit 10 implements a function of the vehicle control apparatus 2 by loading a program stored in the storage unit 40 or a ROM (not shown) onto a RAM (not shown) and executing the program. However, some or all of functions of the processing unit 10 may be implemented by a field-programmable gate array (FPGA) or a hardware circuit.

The processing unit 10a includes a data conformity unit 11a, a data management unit 12a, a data calculation unit 13a, an execution control unit 14a, and a diagnosis unit 15a as a function thereof. The processing unit 10b includes a data conformity unit 11b, a data management unit 12b, a data calculation unit 13b, an execution control unit 14b, and a diagnosis unit 15b as functions thereof. Hereinafter, the data conformity unit 11a and the data conformity unit 11b are collectively referred to as a “data conformity unit 11”, the data management unit 12a and the data management unit 12b are collectively referred to as a “data management unit 12”, the data calculation unit 13a and the data calculation unit 13b are collectively referred to as a “data calculation unit 13”, the execution control unit 14a and the execution control unit 14b are collectively referred to as an “execution control unit 14”, and the diagnosis unit 15a and the diagnosis unit 15b are collectively referred to as a “diagnosis unit 15”.

The data conformity unit 11 is a functional component group that converts a data format between a format of data transmitted to and received from the other vehicle control apparatus 2 via the communication control unit 50 and a data format handled by the data management unit 12. A functional component is a functional block that implements a part of the function implemented by the processing unit 10, and is implemented by the CPU, the GPU, the FPGA, or the hardware circuit.

The data conformity unit 11a of the vehicle control apparatus 2a includes a sensor A conformity unit 111 and a sensor B conformity unit 112 respectively corresponding to the sensor A indicated by the reference numeral 3a and the sensor B indicated by the reference numeral 3b, and a map device conformity unit 113 corresponding to the map information management apparatus 5. The data conformity unit 11b of the vehicle control apparatus 2b includes an actuator A conformity unit 114 and an actuator B conformity unit 115 respectively corresponding to the actuator A indicated by the reference numeral 4a and the actuator B indicated by the reference numeral 4b. Each of these functional components converts a data format in accordance with a data format of the corresponding external apparatus and the data format of the data management unit 12.

A ROM of each of the vehicle control apparatus 2a and the vehicle control apparatus 2b stores software for causing the sensor A conformity unit 111, the sensor B conformity unit 112, the map device conformity unit 113, the actuator A conformity unit 114, and the actuator B conformity unit 115 to implement functions. That is, as will be described below, the vehicle control apparatus 2a can further cause the actuator A conformity unit 114 and the actuator B conformity unit 115 to implement functions.

The data management unit 12 manages data by using an abstracted data format (hereinafter, referred to as “object data”) as will be described below. Therefore, if an operation of the data conformity unit 11 is described in detail, a function of each of the functional components of the data conformity unit 11 includes the following two. That is, a first function is to convert the data format of the data acquired from the other vehicle control apparatus 2 via the communication control unit 50, generate the object data, and output the generated object data to the data management unit 12. A second function is to convert the data format of the object data output from the data management unit 12 and generate data to be transmitted to the other vehicle control apparatus 2.

The data management unit 12 is a functional component group having a function of managing and operating the object data stored in the storage unit 40 of the vehicle control apparatus 2, a function of transmitting an object data operation request to the data management unit 12 of the other vehicle control apparatus 2 and receiving an object data operation request therefrom, and a function of providing another functional component with a common interface.

The data management unit 12 manages and operates the data of the storage unit 40 in a unit of the object data that is a set of data corresponding to a predetermined target element. The “target element” is a conceptual target expressed in common by individual information elements grouped together as the object data, and corresponds to, for example, a detection target of the sensor group 3, and a control target of the actuator group 4. Preferably, for an external sensor in particular, individual environmental elements (an obstacle, a road shape, a traffic rule, or the like) recognized by the external sensor correspond to the target elements. In other words, it is preferable to adopt a method in which hardware referred to as the external sensor is not abstracted, but the data is abstracted in a unit of the environmental element that is the detection target of the external sensor, and the abstracted data is used as the object data.

### (Data Management Unit)

The data management unit 12 includes an object data operation execution unit 121, an object data operation execution control unit 122, a setting information management unit 123, object data operation interfaces 125, and a setting interface 126.

The object data operation execution unit 121 performs a data operation, based on the data operation request received from another functional component by the data management unit 12, on an object data group 142 managed on the storage unit 40. The data operation request is input via the object data operation interfaces 125. When the data operation is performed, the data management unit 12 returns a result thereof to a transmission source of the data operation request. The data operation of the object data includes not only update of the object data, that is, registration, overwriting, and deletion, but also search of the object data.

The object data operation execution control unit 122 determines necessity of writing data to the storage unit 40 of the vehicle control apparatus or necessity of transmission to the other vehicle control apparatus in response to the object data operation request that is accompanied by writing into the object data and is received from another functional component by the data management unit 12, that is, in response to an update operation. At this time, the object data operation execution control unit 122 determines the necessity with reference to the setting information data group 141 to be described below. The data operation request is input via the object data operation interface 125. When determining that data writing is necessary, the object data operation execution control unit 122 passes the object data operation request to the object data operation execution unit 121. Accordingly, the requested writing operation on the object data group 142 is executed.

When determining that transmission to the other vehicle control apparatus is necessary, the object data operation execution control unit 122 extracts the object data satisfying a predetermined condition via the object data operation execution unit 121 as necessary, that is, executes the search operation, and outputs the object data operation request to a network via the communication control unit 50. Therefore, the setting information data group 141 is appropriately set without modifying the functional components of the data conformity unit 11 or the data calculation unit 13, in other words, without modifying the program or reconfiguring the hardware. Thereby, a writing location of the object data can be controlled.

The object data operation execution control unit 122 also has a function of, upon receiving a notification from the execution control unit 14, extracting the object data satisfying a predetermined condition via the object data operation execution unit 121, and outputting a writing operation request related to the extracted object data to the network via the communication control unit 50.

The setting information management unit 123 is a functional component that controls acquisition or change of the setting information data group 141 in accordance with a request received from the execution control unit 14 via the setting interface 126 by the data management unit 12.

The object data operation interfaces 125 correspond to application programming interfaces (API) for another functional component group such as the data conformity unit 11, the data calculation unit 13, and the execution control unit 14 to use the object data operation function provided by the data management unit 12. Although each piece of the object data that constitutes the object data group 142 has a different data structure depending on the target element thereof, the object data operation interfaces 125 provide interfaces allowing any piece of the object data to be operated by a common operation method.

The setting interface 126 provides an interface allowing another functional component group such as the execution control unit 14 to acquire or change the setting information data group 141 that defines behavior of the data management unit 12.

### (Data Calculation Unit)

The data calculation unit 13 is an application group for implementing the function of the vehicle control apparatus 2. The data calculation unit 13 is a functional component group that performs calculation based on the data input from the object data operation interface 125 of the data management unit 12, and outputs data acquired by the calculation to the object data operation interface 125. A calculation processing that implements a complicated function such as automatic driving includes a plurality of processing blocks. The data calculation unit 13 includes a plurality of functional components corresponding to the individual processing blocks. That is, in the present embodiment, automatic driving function is configured with three functional components, that is, a sensor fusion calculation unit 131, a map fusion calculation unit 132, and a traveling control calculation unit 133. As for the three functional components, the sensor fusion calculation unit 131 and the map fusion calculation unit 132 are mounted on the vehicle control apparatus 2a, and the traveling control calculation unit 133 is mounted on the vehicle control apparatus 2b. With calculation processings performed by these functional components, control information on automatic driving of the vehicle on which the vehicle control apparatus 2 is mounted is calculated and output to the actuator group 4 based on various kinds of information detected by the sensor group 3.

The ROM of each of the vehicle control apparatus 2a and the vehicle control apparatus 2b stores software for causing the sensor fusion calculation unit 131, the map fusion calculation unit 132, and the traveling control calculation unit 133 to implement functions. That is, as will be described below, it is also possible to perform all calculations of the sensor fusion calculation unit 131, the map fusion calculation unit 132, and the traveling control calculation unit 133 only with the vehicle control apparatus 2a.

The sensor fusion calculation unit 131 performs an identification and integration processing of the object data for the same target element detected by a plurality of external sensors included in the sensor group 3, and an interpolation processing of missing data based on time-series information.

The map fusion calculation unit 132 performs a processing of comparing the object data identified and integrated by the sensor fusion calculation unit 131 with map data information acquired from the map information management apparatus 5, and adding the map data information (for example, an ID of a lane where another vehicle is traveling) as an attribute to the identified and integrated object data.

Based on calculation results of the sensor fusion calculation unit 131 and the map fusion calculation unit 132, the traveling control calculation unit 133 determines driving behavior, a traveling track, a speed profile, and the like of the vehicle. Further, the traveling control calculation unit 133 calculates control information for the actuator group 4 based on these pieces of determined information, and outputs a calculation result thereof to the data management unit 12 (12b in FIG. 1). The control information output to the data management unit 12 is converted into a communication data format corresponding to each actuator and is output to the network via the communication control unit 50 by the actuator A conformity unit 114 and the actuator B conformity unit 115 of the data conformity unit 11.

### (Execution Control Unit)

The execution control unit 14 is a functional component that controls execution of the functional components that access the data management unit 12, such as the functional components of the data conformity unit 11 and the data calculation unit 13. The execution control unit 14 calls a function for executing calculation of the functional components that access the data management unit 12 in accordance with an order described in a module list to be described below, that is, an execution function, and implements a series of calculation processings of the vehicle control apparatus 2. At this time, the execution control unit 14 refers to the setting information data group 141 via the setting interface 126 of the data management unit 12, and determines necessity of execution of the functional components that access the data management unit 12. The execution control unit 14 does not call the execution function for the functional component set not to be executed, and proceeds to the processing of the next functional component.

### (Diagnosis Unit)

The diagnosis unit 15 is a functional component that diagnoses a state of the vehicle control apparatus 2 to which it belongs and a state of the external apparatus connected via the network, and detects a malfunction. A malfunction in the apparatus to which it belongs can be detected, for example, by monitoring an internal state with a watchdog timer or the like. Further, a malfunction of the external apparatus can be detected by, for example, a method such as keep-alive. The diagnosis unit 15 notifies the execution control unit 14 when various malfunctions are detected.

### (Storage Unit)

The storage unit 40 includes, for example, a storage device such as a hard disk drive (HDD), a flash memory, and a read only memory (ROM), and a memory such as a RAM. The storage unit 40 stores a program to be processed by the processing unit 10, and data groups necessary for the processing, that is, the setting information data group 141, the object data group 142, and the setting change data group 143. Further, the storage unit 40 is also used as a main storage device when the processing unit 10 executes the program, for temporarily storing the data necessary for calculation of the program.

The setting information data group 141 is a set of data related to the setting information that defines the behavior of the data management unit 12. The object data group 142 is a set of object data managed on the storage unit 40 by the data management unit 12. The setting change data group 143 is a set of data to be referred to when the execution control unit 14 dynamically changes the setting information data group 141. Specific examples of the setting information data group 141, the object data group 142, and the setting change data group 143 will be described below.

### (Communication Control Unit)

The communication control unit 50 includes, for example, a network card conforming to a communication standard such as IEEE 802.3 or a controller area network (CAN). The communication control unit 50 transmits data to another device in the vehicle system 1 and receives data therefrom based on various protocols. An interface for data transmission and reception provided by the communication control unit 50 is configured in a form that does not depend on a form of connection with the hardware of the vehicle control apparatus 2 and the external apparatus. For example, an interface for abstracting and handling a hardware device of the vehicle control apparatus 2 is provided by a device driver group, and a general-purpose communication protocol such as TCP/IP operates on the interface. Accordingly, on any vehicle control apparatus, the optional data can be transmitted to the other apparatus and can be received therefrom by using a common interface, for example, a socket interface.

Although the communication control unit 50 is described separately from the processing unit 10 in FIG. 1, a part of the processing of the communication control unit 50 may be executed in the processing unit 10. For example, a device corresponding to a hardware device in the communication processing can be located in the communication control unit 50, and other device driver groups, communication protocol processings, and the like can be located in the processing unit 10. Even in such a configuration, since the interface for transmitting and receiving the data does not change, behavior of the functional component groups of the data conformity unit 11, the data management unit 12, the data calculation unit 13, and the execution control unit 14 in the processing unit 10 does not change.

The sensor group 3 is a set of an external sensor group that includes devices that detect a state around the vehicle and an internal sensor group that includes devices that detect a state of the vehicle. The external sensor group includes, for example, a camera device, a millimeter wave radar, a laser radar, and a sonar. The state of the vehicle includes, for example, a traveling speed, a steering angle, an operation amount of an accelerator, and an operation amount of a brake. Each device that constitutes the sensor group 3 outputs detection information thereof to the in-vehicle network. The external sensor group detects and outputs the environmental elements including an obstacle such as another vehicle, a bicycle, a pedestrian, and a fallen object that exists within a predetermined range from the vehicle, a road shape such as a white line or a road edge, and a traffic rule such as a road sign or a signal, and the like. In the present embodiment, the sensor group 3 includes the sensor A indicated by the reference numeral 3a and the sensor B indicated by the reference numeral 3b.

The actuator group 4 is a device group that controls control elements such as steering, the brake, and the accelerator which determine an operation of the vehicle. The actuator group 4 controls the operation of the vehicle based on operation information on a steering wheel, a brake pedal, an accelerator pedal, and the like operated by the driver, and based on the control information output from the vehicle control apparatus 2.

The map information management apparatus 5 manages and provides digital map information on surroundings of the vehicle, and is, for example, a navigation apparatus. The map information management apparatus 5 includes, for example, digital road map data representing an entire predetermined region or a region around the vehicle, and specifies a map position of the vehicle (a road, a lane, or the like during traveling) on the map data based on vehicle position information determined via a global navigation satellite system (GNSS) reception device or the like. Further, the map information management apparatus 5 provides the vehicle control apparatus 2 with a map position of a specified vehicle and map data on surroundings of the specified vehicle.

Here, characteristics of the functional components that constitute the processing unit 10 (hereinafter, referred to as “processing functional components”) in the vehicle control apparatus 2 according to the present embodiment will be described. As described above, the processing functional components transmit the data via the data management unit 12. Therefore, even when configurations of the processing functional components in the vehicle control apparatus 2a and the vehicle control apparatus 2b are changed, the data management unit 12 is still an interface for the respective data input and output of the processing functional components.

As described above, the data management unit 12 controls, based on the setting information data group 141, the writing location of the object data output from each of the functional components. Therefore, even when a configuration relationship among the functional components that perform data calculation for the vehicle control apparatus 2 is changed by changing a design, a hardware configuration, and the like, an influence is limited as follows. That is, the setting information data group 141 is appropriately set even when the configuration of a functional component is changed. Thereby, the processing unit 10 can implement a series of calculation processings in the vehicle system 1 without changing the input and output interface of the functional component. That is, a static configuration change of the functional component can be implemented without modifying the functional component.

The execution control unit 14 can dynamically control, based on the setting information data group 141, execution of each of the functional components that accesses the data management unit 12. That is, since execution of each of the functional components and a configuration of the object data corresponding thereto can be switched in conjunction with each other, the following advantage is acquired. The advantage is that, by appropriately changing the setting information data group 141 via the setting interface 126, a configuration change of the functional component can be implemented while continuing the series of calculation processings in the vehicle system 1, that is, a dynamic configuration change can be achieved.

In FIG. 1, the data conformity unit 11 that converts the data format between the communication control unit 50 and the data management unit 12 is described separately from the data calculation unit 13. However, the data conformity unit 11 and the data calculation unit 13 are common in that a predetermined calculation is performed on the input data to generate output data. Therefore, the data conformity unit 11 may also be regarded as a part of the data calculation unit 13. In this case, the functional component group of the data calculation unit 13 transmits the data via the communication control unit 50 or the data management unit 12.

### (Setting Information Data Group 141)

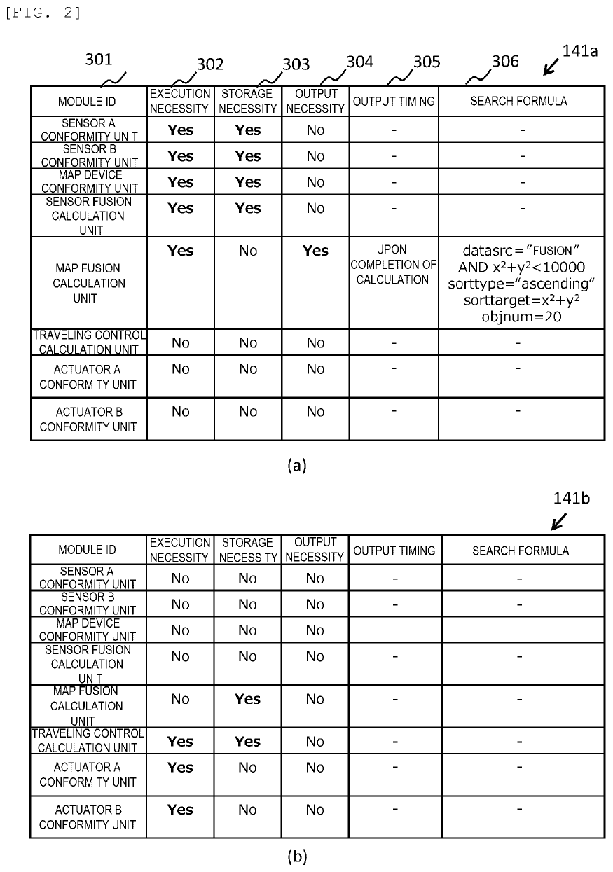

FIG. 2 is a diagram showing an example of the setting information stored in the setting information data group 141. FIG. 2(a) is a table showing the setting information data group 141a stored in the vehicle control apparatus 2a, and FIG. 2(b) is a table showing the setting information data group 141b stored in the vehicle control apparatus 2b. As described above, the setting information data group 141 is stored in the storage unit 40, and is the set of data on the setting information that defines the behavior of the data management unit 12. The setting information management unit 123 of the data management unit 12 reads the setting change data group 143 during activation of the vehicle control apparatus 2, and sets the setting information data group 141 on the memory based on a setting information table corresponding to the activation. As shown in FIG. 2, the setting information data group 141 includes a plurality of records. Each record includes fields of a module ID 301, execution necessity 302, storage necessity 303, output necessity 304, an output timing 305, and a search formula 306.

The field of the module ID 301 stores information for identifying the functional components of the data conformity unit 11 and the functional components of the data calculation unit 13 that access the data management unit 12. In FIG. 2, although names of the functional components shown in FIG. 1 such as the “sensor A conformity unit” are described, an identifier associated with each of the functional components, for example, a functional component ID is used in practice. Hereinafter, a functional component specified by a value in the field of the functional component ID in a certain record is referred to as a “target functional component”. The field of the execution necessity 302 stores information indicating whether to execute a calculation of the target functional component in the vehicle control apparatus.

The field of the storage necessity 303 stores information indicating whether the writing operation request for the object data from the target functional component is to be processed by the vehicle control apparatus. The field of the output necessity 304 stores information indicating whether to transmit the writing operation request for the object data from the functional component to the external apparatus connected via the network. Although “Yes” and “No” that indicate the necessity are expressed in FIG. 2, an identifier of an output destination, for example, an IP address or a host name may be described. In this case, for example, when the output destination information is not described, the transmission is not required; and when the output destination is described, the writing operation request is transmitted to an apparatus corresponding to the output destination.

The field of the output timing 305 is set when “Yes” is stored in the field of the output necessity 304. The field of the output timing 305 stores information indicating a timing when the transmission to the external apparatus is performed. The field of the output timing 305 stores, for example, “upon completion of calculation” or “during operation”. “Upon completion of calculation” means that the transmission is executed when the calculation processing of the target functional component is completed. “During operation” means that the transmission is executed during execution of each object data writing operation requested from the target functional component.

The field of the search formula 306 is set when “Yes” is stored in the field of the output necessity 304. The field of the search formula 306 stores a conditional statement for extracting a target to be transmitted to the external apparatus. Further, a value in the field of the search formula 306 is in conjunction with a value of the field of the output timing 305 as follows. When “upon completion of calculation” is stored in the field of the output timing 305, a search stored in the field of the search formula 306 is applied to the entire object data group 142 stored in the storage unit 40. On the other hand, when “during operation” is stored in the field of the output timing 305, the search stored in the field of the search formula 306 is applied to the object data for which the writing request is made by the target functional component.

The field of the search formula 306 stores the conditional statement created in accordance with a predetermined grammar. The conditional statement is expressed by, for example, a combination of a key character string, a calculation operator, a logic operator, a comparison operator, and the like that specify a data element of the object data or a search formula parameter. In the example of FIG. 2, the field of the search formula 306 in the map fusion calculation unit stores a conditional formula “datasrc=“fusion” AND x²+y²<10000” and search parameters “sorttype=“ascending””, “sorttarget=x²+y²”, and “objnum=20”. The above-described conditional formula represents a search formula that extracts the object data whose data source is “fusion” and whose relative distance is less than 100 m. Among the three search parameters described above, the first two search parameters represent parameters related to sorting a search result and respectively specify a sort order and a sort target. In this example, values of x²+y² are sorted in an ascending order.

The third search parameter specifies an upper limit value of the number of object data to be output. In this example, up to 20 pieces of the object data can be transmitted. These conditional formulae allow only the necessary object data to be extracted and transmitted, and at the same time, even when the number of the corresponding object data is too large, an upper limit for the number of transmission can be controlled based on a predetermined priority. An expression form of the search formula 306 is not limited thereto, and may be expressed by a structured query language (SQL) or the like. By using such a grammar, the following conditional formula can also be constructed which performs comparison with reference to a speed ve of the own vehicle that is a value of a different object data. That is, a conditional formula “x>0 AND x²+y²<(”speed vₑ of own vehicle”×5)²” (extraction of the object data that is within a forward range and advances in 5 seconds) can be constructed.

The examples of the setting information data groups 141a and 141b of the vehicle control apparatuses 2a and 2b are respectively shown in FIG. 2, which correspond to the setting information in the vehicle system 1 shown in FIG. 1.

That is, in the setting information data group 141a shown in FIG. 2(a), since the sensor A conformity unit 111, the sensor B conformity unit 112, the map device conformity unit 113, the sensor fusion calculation unit 131, and the map fusion calculation unit 132 in the vehicle control apparatus 2a are operating, values in the fields of the execution necessity 302 corresponding thereto are set to “Yes”. Further, since the object data necessary for the calculations of the sensor fusion calculation unit 131 and the map fusion calculation unit 132 needs to be stored in the object data group 142a of the storage unit 40a, the following settings are made. That is, “Yes” is set in the corresponding fields of the storage necessity 303 so that output results of the sensor A conformity unit 111, the sensor B conformity unit 112, the map device conformity unit 113, and the sensor fusion calculation unit 131 are stored. On the other hand, since an output result of the map fusion calculation unit 132 is used in the traveling control calculation unit 133 executed in the vehicle control apparatus 2b, a value in the field of the output necessity 304 of the map fusion calculation unit 132 is set to “Yes”, and various conditions at that time are set in the fields of the output timing 305 and the search formula 306.

On the other hand, since the actuator A conformity unit 114, the actuator B conformity unit 115, and the traveling control calculation unit 133 operate in the vehicle control apparatus 2b, “Yes” is set in the fields of the execution necessity 302 corresponding thereto. Since the object data, which is necessary for calculation of the traveling control calculation unit 133 and for output of the actuator A conformity unit 114 and the actuator B conformity unit 115, needs to be stored in the object data group 142b of the storage unit 40b, the following settings are made. That is, “Yes” is set in the corresponding fields of the storage necessity 303 so that output results of the map fusion calculation unit 132 and the traveling control calculation unit 133 are stored.

### (Object Data Group 142)

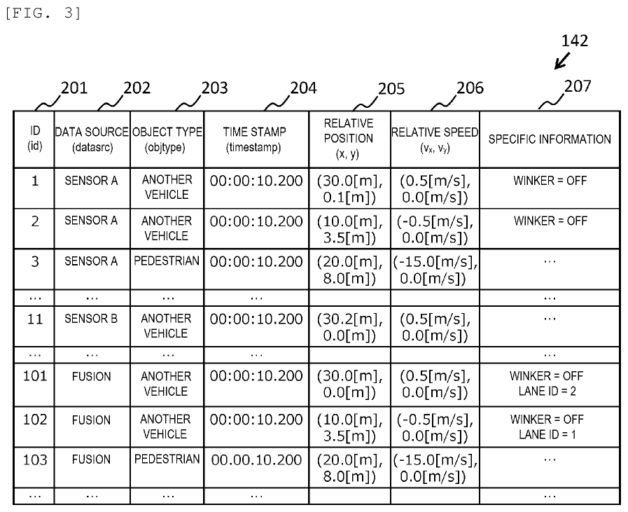

FIG. 3 is a table showing an example of the object data stored in the object data group 142. As described above, the object data group 142 is the set of object data stored in the storage unit 40 and managed by the data management unit 12. As shown in FIG. 3, the object data group 142 includes a plurality of records, and each record corresponds to one piece of the object data. Hereinafter, the object data serving as a target of description in a certain record is referred to as “target object data”. Hereinafter, the record is also referred to as a “data entry”.

Each record of the object data group 142 includes an ID 201, a data source 202, an object type 203, a time stamp 204, a relative position 205, a relative speed 206, and specific information 207 in which different information is stored depending on the data source and a type of the target element. In each data element, a key character string is set which can be specified in the field of the search formula 306 of the setting information data group 141. That is, “id” is set in the ID 201, “datasrc” is set in the data source 202, “objtype” is set in the object type 203, “timestamp” is set in the time stamp 204, “x” and “y” are set in the relative position 205, and “vₓ” and “v_{y}” are set in the relative speed 206. Although not shown in FIG. 3, it is assumed that a predetermined key character string is assigned to each of the data elements stored in the specific information 207.

The field of the ID 201 stores an identifier for identifying the target element indicated by the target object data. The same value is set in the fields of the ID 201 for a plurality of pieces of object data indicating the same target element, for example, the same vehicle. In the example of FIG. 3, the values are set so that there is no duplication in the entire object data group 142, but uniqueness may be guaranteed in combination with the data source 202 and the like. The field of the data source 202 stores information indicating a generation source of the target object data. For example, in a first data entry (id=1) in FIG. 3, the “sensor A” is set in the field of the data source 202, which indicates that the generation source of the target object data is the sensor A included in the sensor group 3, strictly speaking, the sensor A conformity unit 111.

The field of the object type 203 stores information indicating a conceptual type of the target element indicated by the target object data. Examples of the types of the target element stored in the object type 203 include another vehicle, a pedestrian, a white line and the like. The field of the time stamp 204 stores time information on the target object data. For example, when the generation source of the target object data indicated by the data source 202 is a sensor included in the sensor group 3, the time information stored in the field of the time stamp 204 corresponds to a time point when the target object data is detected. Accordingly, when a state of the target object data is estimated at an optional point time, a correction can be made according to time on the target object data. Further, the time stamp 204 may store other time information, for example, an update time point of the target object data in the storage unit 40, in accordance with a time management policy of the object data in the vehicle control apparatus 2.

The field of relative position 205 stores information indicating a relative position of the target element indicated by the target object data with respect to the vehicle. A coordinate of the relative position is expressed by, for example, an x-y coordinate system centered on the vehicle. The x-axis is a central axis that passes through a reference point of the vehicle, for example, a center of gravity of the vehicle in a front-rear direction (a forward direction is a front direction). The y-axis is a central axis that passes through the reference point of the vehicle in a left-right direction (the left direction is the front direction). For example, the first data entry (id=1) in FIG. 3 means that the target element is located 30 m ahead of the vehicle and 0.1 m to a left side of the vehicle. The field of the relative speed 206 stores information indicating a relative speed of the target element indicated by the target object data with respect to the vehicle. Coordinate axes of the relative speed is common to that of the relative position 205.

The field of the specific information 207 stores different data for each piece of the object data in accordance with a combination of the data source 202 and the object type 203. For example, winker information is stored in the object data of datasrc =“sensor A” and of objtype=“another vehicle”, but not stored in the object data of objtype=“pedestrian” and the object data of datasrc=“sensor B”. This is because that information which can be detected is different for each sensor, and information identified in accordance with the type of the target element is different.

### (Setting Change Data Group 143)

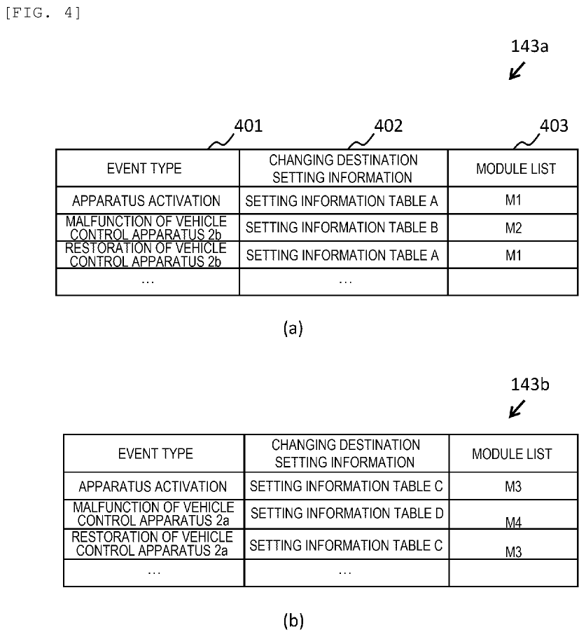

FIG. 4 is a diagram showing an example of the setting change data group 143. FIG. 4(a) is a table showing an example of the setting change data group 143a, and FIG. 4(b) is a table showing an example of the setting change data group 143b. As described above, the setting change data group 143 is stored in the storage unit 40. The setting change data group 143 is a set of data to be referred to when the execution control unit 14 dynamically changes the setting information data group 141. The setting change data group 143 includes a plurality of records. Each record stores an event serving as a trigger to cause a setting change to be executed and setting information after the change. When detecting a predetermined event, the execution control unit 14 changes the setting information data group 141 to setting information corresponding to the event in the setting change data group 143. As shown in FIG. 4, each record of the setting change data group 143 includes fields of an event type 401, changing destination setting information 402, and a module list 403.

The field of the event type 401 stores information that indicates an event serving as a trigger which causes the setting change to be executed. “Apparatus activation” means an activation event of the vehicle control apparatus 2. “Malfunction of vehicle control apparatus 2b” means a malfunction detection event of the vehicle control apparatus 2b. “Restoration of vehicle control apparatus 2b” means an event in which it is detected that the vehicle control apparatus 2b has been restored through reactivation or the like after the malfunction.

The field of the changing destination setting information 402 stores the setting information to be changed to when the event of the event type 401 occurs. The setting information here corresponds to the setting information data group 141. The field of the module list 403 stores a name of the module list to be used after the occurrence of the event of the event type 401. The module list is a list in which the functional components are arranged in an order to be executed.

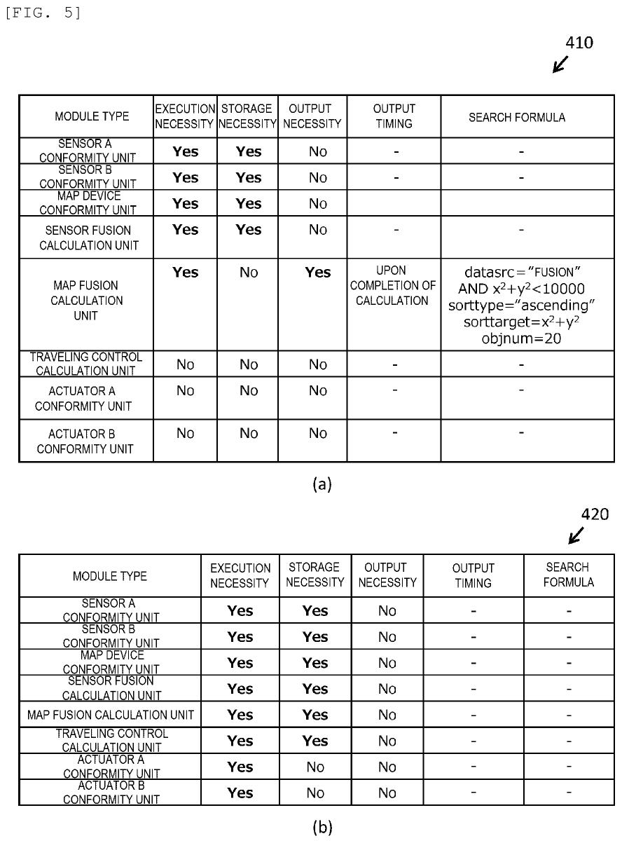

FIG. 5(a) is a table showing an example of a setting information table A indicated by a reference numeral 410, and FIG. 5(b) is a table showing an example of a setting information table B indicated by a reference numeral 420. The setting information table A indicated by the reference numeral 410 has the same structure and stored information as those of the setting information data group 141a shown in FIG. 2(a). The setting information table B indicated by the reference numeral 420 has the same structure as that of the setting information data group 141a, but has stored information different from that of the setting information data group 141a. An operation example will be described below with reference to FIG. 5.

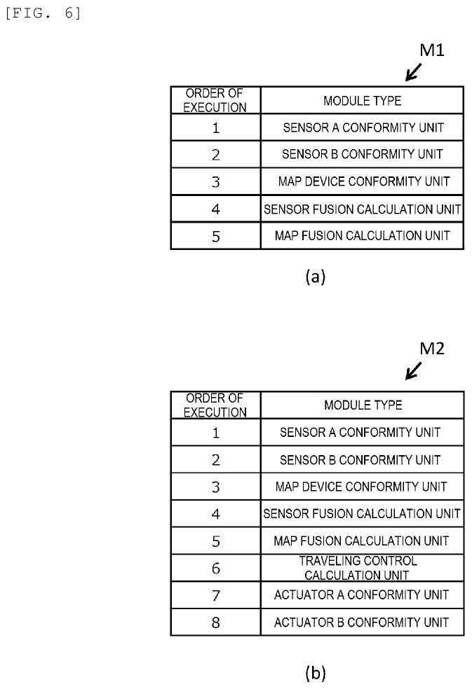

FIG. 6(a) is a table showing an example of a module list M1, and FIG. 6(b) is a table showing an example of a module list M2. Further, FIG. 6 corresponds to FIG. 5. That is, the module types for which “YES” is stored in the fields of the execution necessity in FIG. 5(a), that is, the functional components, are described in the module list M1 in FIG. 6(a). Similarly, the module types for which “YES” is stored in the fields of the execution necessity in FIG. 5(b), that is, the functional components, are described in the module list M2 in FIG. 6(b). It should be noted that there is no particular reason for the same order of description in FIGS. 5 and 6. There is no relationship between the order of description of the functional components and an order of execution of the functional components in the setting information table.

### (Object Data Operation Interfaces)

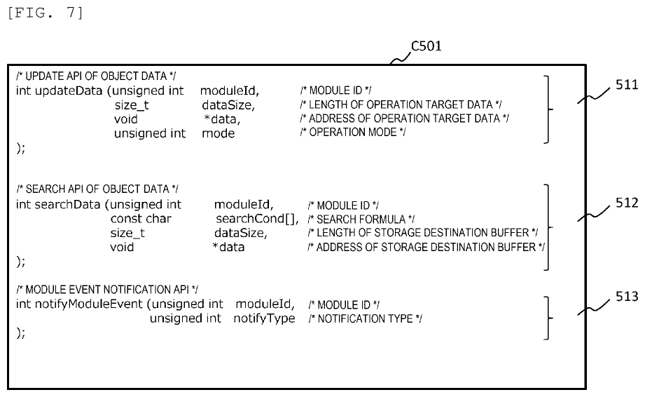

A pseudocode group C501 shown in FIG. 7 represents a part of a header file when each object data operation interface 125 is described in C language. The pseudocode group C501 includes a pseudocode 511 representing an update API of the object data, a pseudocode 512 representing a search API of the object data, and a pseudocode 513 representing a module event notification API. Hereinafter, the APIs represented by these pseudocodes will be described.

An “updateData”, which is the update API of the object data represented by the pseudocode 511, is an API that performs an update operation on the object data group 142 of the predetermined vehicle control apparatus 2 of the vehicle system 1. The update operation on the object data group 142 includes a “registration operation”, an “overwriting operation”, and a “deletion operation”. The registration operation is an operation of inserting new object data into the object data group 142. The overwriting operation is an operation of overwriting the predetermined object data stored in the object data group 142 with new object data. The deletion operation is an operation of deleting the predetermined object data stored in the object data group 142. As represented by the pseudocode 511, an argument of the update API includes a “moduleID” that is a module ID which identifies the functional component which calls the API, a “dataSize” that is a data length of the object data of an operation target, a “data” that is an address of the object data of the operation target, and a “mode” that is an operation mode which identifies a type of the update operation to be executed. The module ID in the argument corresponds to the module ID 301 in FIG. 2. The data length and the address of the object data of the operation target are stored as argument values only when the operation mode is the registration operation or the overwriting operation.

When the update API of the object data is called, the argument information is passed to the object data operation execution control unit 122. Since the vehicle control apparatus 2 on which the specified update operation is executed is determined based on the setting of the setting information data group 141 as described above, the update operation is not necessarily applied to the object data group 142 on the vehicle control apparatus 2 from which the API is called. When the update operation is applied to the object data group 142, the argument information is passed to the object data operation execution unit 121, and the specified update operation is executed.

A “searchData”, which is the search API of the object data represented by the pseudocode 512, is an API of the “search operation” of acquiring the object data corresponding to a predetermined search condition from the object data group 142 of the vehicle control apparatus 2 from which the API is called. As represented by the pseudocode 512, an argument of the search API includes “moduleID” that is a module ID, “searchCond” that is a search formula, and “dataSize, data” that is information on a buffer that stores a search result. The search formula of the API corresponds to the search formula 306 in FIG. 2.

When the search API of the object data is called, the argument information is passed to the object data operation execution unit 121. The object data operation execution unit 121 analyzes and interprets a character string of the passed search formula in accordance with a predetermined grammar, and extracts a list of the object data corresponding to a predetermined condition from the object data group 142. When a sorting condition is set in the search formula, an aligned result in accordance therewith is stored in the buffer and returned to a calling source.

A “notifyModuleEvent”, which is the module event notification API represented by the pseudocode 513, is an API for notifying the data management unit 12 of the event related to the specified module ID. As represented by the pseudocode 513, an argument of the API includes “moduleID” that is a module ID, and “notifyType” that is a notification type. Examples of the notification type in the argument include a “calculation execution completion notification”. The calculation execution completion notification is used when the data management unit 12 is notified that calculation execution of the functional component corresponding to the module ID in the argument is completed.

### (Flowchart of Periodic Processing)

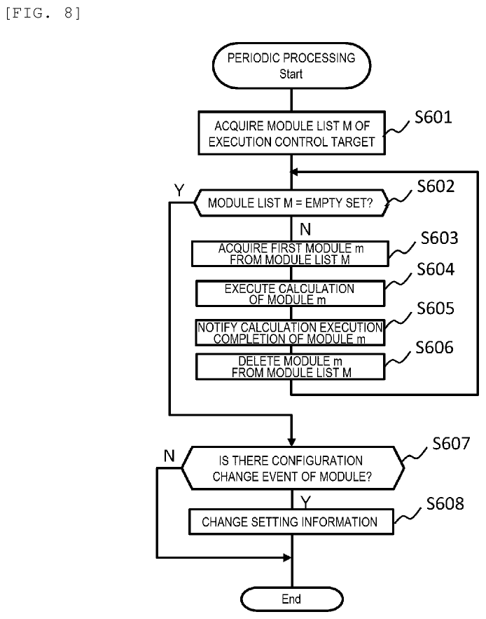

FIG. 8 is a flowchart showing the periodic processing of the execution control unit 14 in the vehicle control apparatus 2. The execution control unit 14 executes the periodic processing shown in FIG. 8 at a predetermined time interval, for example, a period of 100 ms. Hereinafter, a functional component is also referred to as a “module”.

The execution control unit 14 first acquires a module list M of an execution control target in S601. Further, the module list M is a copy of the module list stored in the field of the module list 403 in the setting change data group 143. For example, when an immediately preceding event is “apparatus activation”, a copy of the module list M1 is acquired as the module list M. Further, since the module list M is the copy of the module list M1, although a part of the module list M is deleted in the following description, this processing does not affect the module list M1.

In subsequent S602, the execution control unit 14 determines whether the module list M is an empty set. When it is determined that the module list M is not an empty set, the processing proceeds to S603. When it is determined that the module list M is an empty set, the processing proceeds to S607. In S603, the execution control unit 14 acquires a first module m of the module list M. In subsequent S604, the execution control unit 14 calls an execution function of the module m and executes calculation of the module m. When execution of the calculation is completed, the execution control unit 14 uses the module event notification API of the object data operation interface 125 of the data management unit 12 shown in FIG. 7, to notify the data management unit 12 of the calculation execution completion event of the module m (S605), and deletes the module m whose calculation has been executed from the module list M (S606). The processing returns to S602.

When the processings of S603 to S606 are applied to all modules in the module list M, the module list M becomes empty, that is, becomes an empty set, and the processing proceeds to S607. In S607, the execution control unit 14 determines whether there is a configuration change event of the module. Here, the configuration change event of the module corresponds to the event type 401 of the setting change data group 143 in FIG. 4, and is detected by the diagnosis unit 15. When it is determined that there is no configuration change event of the module (S607: N), the processing shown in FIG. 8 ends. When it is determined that the configuration change event of the module is generated (S607: Y), the execution control unit 14 changes the setting information (S608), and then the processing shown in FIG. 8 ends. More specifically, the execution control unit 14 refers to the setting change data group 143 to specify the changing destination setting information 402 corresponding to the event, and uses the setting interface 126 of the data management unit 12 to rewrite the setting information data group 141 via the setting information management unit 123.

By the processing described above, one cycle of the calculation processing for implementing the function of the vehicle control apparatus 2, that is, an application processing, is executed. In the vehicle control apparatus 2, the processing shown in FIG. 8 is periodically executed, thereby implementing functions of ADAS or automatic driving in the vehicle system 1.

### (Flowchart of Object Data Update Processing)

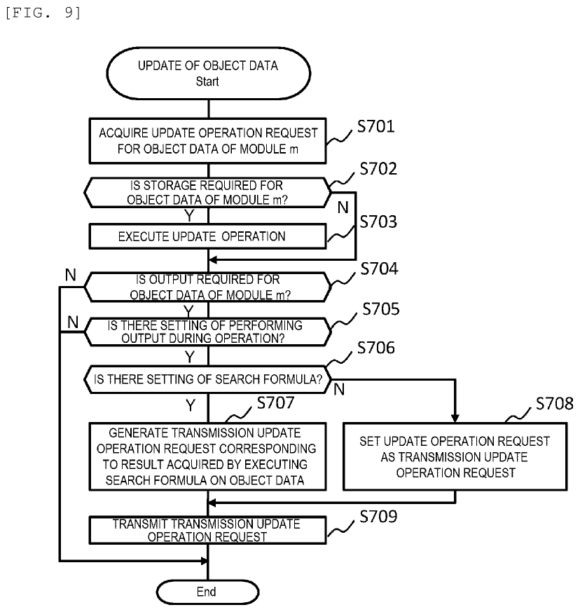

FIG. 9 is a flowchart showing an object data update processing by the object data operation execution control unit 122 of the data management unit 12. When the above-described update API of the object data is called by the functional components of the data conformity unit 11 or the data calculation unit 13, the data management unit 12 executes the processing shown in FIG. 9.

The object data operation execution control unit 122 acquires an update operation request for the object data of the module m (S701), which corresponds to the call for the update API from the data conformity unit 11 and the data calculation unit 13, and the update operation request for the object data corresponds to a data group passed as the argument of the update API. Next, in S702, the object data operation execution control unit 122 refers to the storage necessity 303 of the data entry corresponding to the module m in the setting information data group 141, to determine whether the object data requested based on the update operation request is stored in the object data group 142 of the apparatus. When the object data operation execution control unit 122 determines that “No” is stored in the field of the storage necessity 303 of the module m (S702: N), the processing proceeds to S704 without executing the update operation. When “Yes” is stored in the storage necessity 303 of the module m (S702: Y), the update operation request is passed to the object data operation execution unit 121, and the processing proceeds to S703.

In S703, the object data operation execution unit 121 executes the data operation on the object data group 142 stored in the storage unit 40 in accordance with the instruction of the update operation request, and the processing proceeds to S704. Further, the data operation includes the “registration operation”, the “overwriting operation”, and the “deletion operation” as described above. However, in either case, the data entry corresponding to object data of an update operation request target is specified from the object data group 142, and a next specified operation (registration, overwriting, and deletion) is executed. Further, the data entry is specified by a predetermined data element or a combination of a plurality of data elements included in the object data, for example, a combination of the ID 201 and the data source 202 in FIG. 3.

In S704, the object data operation execution control unit 122 refers to the output necessity 304 of the data entry corresponding to the module m in the setting information data group 141, to determine whether to output the update operation request to outside as an object data update operation request message. When the object data operation execution control unit 122 determines that the output necessity 304 of the module m is “No” (S704: N), the processing shown in FIG. 9 ends. When the object data operation execution control unit 122 determines that the output necessity 304 of the module m is “Yes” (S704: Y) , the processing proceeds to S705. In S705, the object data operation execution control unit 122 refers to the output timing 305 of the data entry corresponding to the module m in the setting information data group 141, to determine whether the setting value is one of “during operation” and “upon completion of calculation”. When it is determined that the setting value of the output timing 305 is “upon completion of calculation” (S705: N), the processing shown in FIG. 9 ends. When the object data operation execution control unit 122 determines that the setting value of the output timing 305 is “during operation” (S705: Y), the processing proceeds to S706.

In S706, the object data operation execution control unit 122 refers to the search formula 306 of the data entry corresponding to the module m in the setting information data group 141, to check whether the search formula is described in the field of the search formula 306. When the object data operation execution control unit 122 determines that no search formula is described (S706: N), the update operation request is directly set as a transmission update operation request (S708), and is transmitted to the outside of the apparatus as an object data update operation request message (S709). The processing shown in FIG. 9 ends. When the object data operation execution control unit 122 determines that the search formula is described (S706: Y), the processing proceeds to S707. The described search formula is applied to object data of a target of the update request, to extract object data of a transmission target. Thereafter, the object data operation execution control unit 122 generates the transmission update operation request corresponding to the object data of the transmission target, and transmits the generated transmission update operation request to the outside of the apparatus as the object data update operation request message (S709). The processing shown in FIG. 9 ends.

### (Flowchart of Completion Notification Reception Processing)

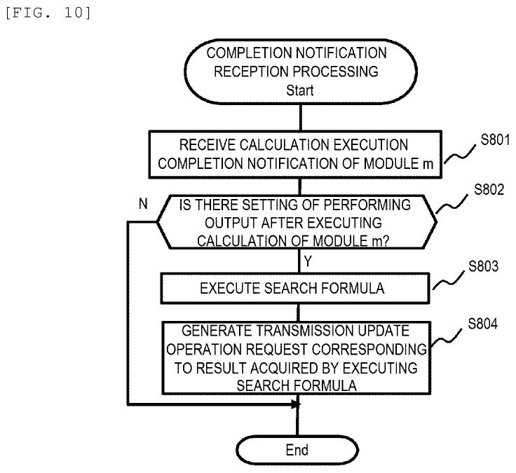

FIG. 10 is a flowchart showing the completion notification reception processing when the data management unit 12 receives the calculation execution completion notification. The completion notification reception processing shown in FIG. 10 is executed by the execution control unit 14 when the above-described module event notification API is called.

In S801, the object data operation execution control unit 122 first receives a calculation execution completion notification of the module m from the execution control unit 14. The reception corresponds to calling the module event notification API in which the “calculation execution completion notification” is specified as the notification type of the argument. In S802, the object data operation execution control unit 122 refers to the timing 305 of the data entry corresponding to the module m in the setting information data group 141, to determine whether the setting value is “upon completion of calculation”. When the object data operation execution control unit 122 determines that the setting value is not “upon completion of calculation” (S802: N), the processing shown in FIG. 10 ends. When the object data operation execution control unit 122 determines that the setting value is “upon completion of calculation” (S802: Y), the processing proceeds to S803.

In S803, the object data operation execution control unit 122 refers to the search formula 306 of the data entry corresponding to the module m in the setting information data group 141, to acquire the object data serving as a target from the object data group 142 based on the set search formula. Specifically, the object data operation execution control unit 122 uses the search formula to generate a search operation request, and passes the generated search operation request to the object data operation execution unit 121. Thereafter, the object data operation execution unit 121 executes the search operation on the object data group 142 of the storage unit 40 in accordance with the search operation request, and returns an extracted result to the object data operation execution control unit 122.

In subsequent S804, the object data operation execution control unit 122 generates a transmission update operation request corresponding to the object data acquired in S803, transmits the generated transmission update operation request to the outside of the apparatus as the object data update operation request message, and ends the processing shown in FIG. 10.

### (Object Data Update Operation Request Message 900)

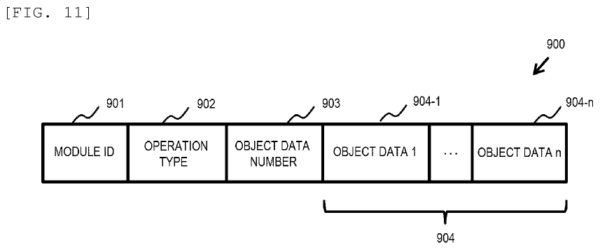

FIG. 11 is a table showing an example of the object data update operation request message 900 transmitted by the vehicle control apparatus 2. However, in FIG. 11, header information and the like related to a communication protocol are not shown. The object data update operation request message 900 includes a module ID 901, an operation type 902, an object data number 903, and an object data group 904. The object data group 904 includes object data 904-1, object data 904-2 . . . and object data 904-n.

The object data update operation request message 900 is information corresponding to the argument of the update API of the object data operation interface 125. The vehicle control apparatus 2, which receives the object data update operation request message 900, can call the update API of the object data operation interface 125 by using the received object data update operation request message 900 as the argument. The module ID 901 represents a module ID corresponding to the functional component of a calling source of the update operation, that is, the first argument of the update API pseudocode 511 shown in FIG. 7. Further, the operation type 902 represents the operation type of the update operation, that is, the second argument of the update API pseudocode 511 shown in FIG. 7. The object data number 903 represents the number of entries of the object data group 904. The object data group 904 is a list of object data of update operation targets. That is, in the example shown in FIG. 11, since the number of the object data is “n”, the object data group 904 includes the object data 904-1, the object data 904-2 . . . and the object data 904-n.

By the above-described processing, the configuration change of the functional component can be implemented while continuing a series of calculation processings in the vehicle system 1, that is, the dynamic configuration change can be achieved.

### (Operation Example)

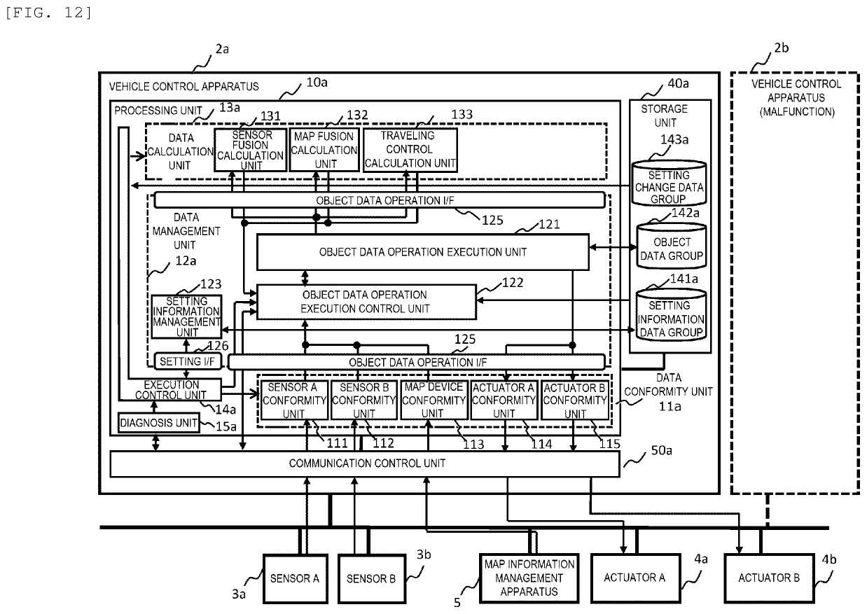

FIG. 12 is a diagram showing an operation example of the dynamic configuration change in the vehicle system 1. FIG. 12 represents a state where since the vehicle control apparatus 2b has a malfunction while the vehicle system 1 is operating in the state shown in FIG. 1, an application that operates on the vehicle control apparatus 2b is activated on the vehicle control apparatus 2a, and thus function maintenance, that is, a fail-operational function of the vehicle system 1 is implemented. Hereinafter, a state where the vehicle control apparatus 2a and the vehicle control apparatus 2b operate cooperatively as shown in FIG. 1 is referred to as a cooperative operation state, and a state where the vehicle control apparatus 2a operates alone as shown in FIG. 12 is referred to as a single operation state.

In order to maintain the function of the vehicle system 1, a calculation result of the vehicle control apparatus 2a for the data input of the sensor group 3, in other words, the data output to the actuator group 4, needs to be equivalent to that in FIG. 1. For this purpose, an input and output relationship among the functional components of the data conformity unit 11a and the data calculation unit 13a in FIG. 12 needs to be equivalent to that in FIG. 1.

FIG. 12 differs from the state shown in FIG. 1 in that the traveling control calculation unit 133 and the conformity units 114 and 115 for the actuators are added on the vehicle control apparatus 2a. Therefore, at least these functional components need to be executed on the vehicle control apparatus 2a in the single operation state. Further, the calculation result of the map fusion calculation unit 132 needs to be transmitted to the vehicle control apparatus 2b until then. However, since the traveling control calculation unit 133 is moved to the vehicle control apparatus 2a, it is necessary to make a change so as to store the calculation result to the storage unit 40a of the vehicle control apparatus 2a. In this manner, when the dynamic configuration change is performed, it is necessary to change the functional component targets to be executed on the vehicle control apparatus while maintaining a consistency of the storage location of the calculation result of each of the functional components.

An operation of the vehicle control apparatus 2a during the malfunction of the vehicle control apparatus 2b will be described. First, the malfunction of the vehicle control apparatus 2b is detected with the diagnosis unit 15a of the vehicle control apparatus 2a based on lack of the keep-alive or the like, and the execution control unit 14a is notified of the malfunction as an event. In this state, the execution control unit 14a determines that a configuration change event of the malfunction of the vehicle control apparatus 2b has been generated in S607 of the periodic processing shown in FIG. 8 and executed periodically (S607: Y), and the processing proceeds to S608. In S608, the execution control unit 14a refers to the corresponding entry of the setting change data group 143a in FIG. 4 to specify the changing destination setting information. In the example of FIG. 4, since the setting information table B corresponds thereto, the execution control unit 14a uses the setting interface 126 of the data management unit 12a to rewrite the setting information data group 141a with contents of the setting information table B via the setting information management unit 123.

When the execution control unit 14a executes the processing of FIG. 8 in a next period by rewriting the setting information data group 141a, execution of the module and the storage destination of the data thereof are controlled based on the setting information of the setting information table B. The setting information on the setting information data group 141a before the malfunction and the setting information on the setting information data group 141a after the malfunction are mainly different in that the execution necessity 302 of the traveling control calculation unit 133 and the execution necessity 302 of the actuator conformity units 114 and 115 are changed to “Yes”, and that the storage necessity 303 of the map fusion calculation unit is changed to “Yes”, and the output necessity 304 of the map fusion calculation unit is changed to “No”. With such setting, execution of the functional components as shown in FIG. 12 and the data input and output relationship can be implemented, and the function of the vehicle system 1 can be maintained equivalent to that in FIG. 1. Further, as described above, since the input and output interface of the functional component is the object data operation interfaces 125 of the data management unit 12 or an interface provided by the communication control unit 50, and both interfaces are general-purpose interfaces independent of the apparatus, there is no program modification that accompanies the configuration change.

According to the first embodiment described above, the following operational effects are acquired.

(1) The vehicle control apparatus 2a is communicably connected to the vehicle control apparatus 2b that is the external apparatus. The vehicle control apparatus 2a includes: the communication control unit 50a that controls the data transmission to and reception from the vehicle control apparatus 2b; the data management unit 12a that manages the object data; the data conformity unit 11a and the data calculation unit 13a which include one or more functional components that perform the predetermined calculation by using the object data acquired from the data management unit 12a or the communication control unit 50a and that output the object data acquired by the predetermined calculation to the data management unit 12a; the setting information data group 141a in which the information on the writing destination of the object data for each of the functional components, that is, the values in the fields of the storage necessity 303 and the output necessity 304, is stored; and the storage unit 40a that stores the object data. The data management unit 12a controls the writing destination of the object data based on the setting information data group 141a.

In this manner, according to the present embodiment, the software configuration is made which can control execution of functional component and the output destination, that is, the storage destination, of the data by using the setting information data group 141 without changing the input and output interface of the functional component. Thereby, the dynamic configuration change of the application can be dealt with. Further, the setting information data group 141 is changed, whereby the static configuration change of the application can be dealt with. That is, storage and communication of unnecessary data can be reduced.

According to the present embodiment, the storage destination of the object data output by the functional component as the calculation result is controlled based on the setting information data group 141. Since the setting information data group 141 manages the setting information in association with the functional component of the output source of the object data, information on identifying the functional component may be included in the update operation interface of the functional component. Therefore, each of the functional components does not need to be aware of the output destination of the object data. For example, even when the functional component that uses the object data is added or deleted, there is no need to modify the functional component of the output source. Therefore, static or dynamic addition or deletion of the functional component can be flexibly performed.

According to the present embodiment, the common interface that generally enables the search operation, the update operation, and the like of the data is adopted for the input and output interface of each of the functional components related to the calculation processing. Therefore, the data transmission among all the functional components related to the calculation processing can be controlled in a uniform manner during calling the common interface. Accordingly, as described above, the storage destination of the data can be easily controlled with the setting information. If such a common interface is not used, since the data management unit individually generates an interface for each of the functional components, it is difficult to control the storage destination of the data and the like in a uniform manner with the setting information or the like.

(2) The setting information data group 141a includes the external output necessity information related to necessity of outputting the object data to the external apparatus for each of the functional components, that is, the value in the field of the output necessity 304. When the external output necessity information is output necessary, that is, “Yes” is stored in the external output necessity information, the data management unit 12a outputs the object data to the vehicle control apparatus 2b via the communication control unit 50a.

Therefore, since the setting of the storage destination of the data is dynamically changed when the configuration of the functional component is changed, it is not necessary to share all the data among the plurality of apparatuses in advance as in the related art. Therefore, transmission and storage of the unnecessary data that is not used can be reduced, and consumption of a network bandwidth and consumption of a storage capacity can be reduced.

(3) The vehicle control apparatus 2a includes a calculation execution control unit 14a that controls execution of the functional component. The setting information data group 141a includes the execution necessity information related to necessity of execution of the functional component, that is, the value in the field of the execution necessity 302. The calculation execution control unit 14a executes the predetermined calculation of one of the functional components when the execution necessity information is execution necessary. Therefore, the vehicle control apparatus 2a can easily control execution of the functional component.

(4) The storage unit 40a stores a plurality of pieces of setting information respectively corresponding to a plurality of events, for example, the setting information table A and the setting information table B that are shown in FIG. 5. When any one of the plurality of events is detected, the data management unit 12a and the calculation execution control unit 14a operate based on the setting information corresponding to the detected event. Therefore, the vehicle control apparatus 2a can change the operation by changing the setting corresponding to a detected event.

(5) The storage unit 40a stores the setting change data group 143a in which an event and the setting information to be applied when the event is detected are associated with each other. When any one of the plurality of events is detected, the data management unit 12a and the calculation execution control unit 14a specify the setting information data group 141a to be applied with reference to the setting change data group 143a, and operate based on the specified setting information data group 141a. Therefore, the vehicle control apparatus 2a can change the operation by referring to the setting change data group 143a set in advance.

(6) The events include a “malfunction of vehicle control apparatus 2b” that is a malfunction of the traveling control calculation unit 133. The traveling control calculation unit 133 is a functional component that operating on the vehicle control apparatus 2b. The setting information table B corresponding to the “malfunction of vehicle control apparatus 2b” includes that execution of the first functional component is necessary. Therefore, the vehicle control apparatus 2a can maintain the function of the vehicle system 1 by executing on its own the functional component executed in the other apparatus whose malfunction has been detected.

(7) The setting information data group 141a may include, in the field of the search formula 306, a conditional formula for reading a target to be output to the vehicle control apparatus 2b from the object data managed by the data management unit 12a for each of the functional components. When the search formula 306 is included in the setting information data group 141a for the functional component that has executed the predetermined calculation, the execution control unit 14a reads the object data conforming to the search formula 306 from the object data managed by the data management unit 12a (S804 in FIG. 10), and outputs the read object data to the vehicle control apparatus 2b.

According to the present embodiment, each of the functional components related to the calculation processing is configured to extract and acquire the data necessary for the search operation from the object data group 142 managed by the data management unit 12. Therefore, when the data entry necessary for calculation of the functional component is included in the object data group 142, the necessary data entry can be extracted in the same manner via search operation regardless of whether other unnecessary data entries are included.

For example, in FIG. 12, the traveling control calculation unit 133 extracts and acquires the necessary data entry by executing the search operation, via the object data operation interface 125, on the object data group 142a including all the object data after execution of the map fusion calculation unit 132. On the contrary, in the state of FIG. 1 before the configuration change, although the traveling control calculation unit 133 executes the search operation on the object data group 142b, the object data group 142b only stores the object data satisfying the condition of the search formula 306 of the data entry of the map fusion calculation unit 132 in FIG. 2. Since the purpose of the search formula 306 specified here is to extract and transmit the necessary object data by the traveling control calculation unit 133, the search formula 306 is equivalent to the search formula specified by the search operation executed by the traveling control calculation unit 133. Therefore, in a state where only the data entry necessary for calculation of the traveling control calculation unit 133 is included in the object data group 142b, the data that can be acquired by the traveling control calculation unit 133 via the search operation is the same as that in FIG. 12. In a case of a structure where the functional component does not use the search operation, since different amounts of the object data groups are handled in FIGS. 1 and 12, it is difficult to acquire the same calculation result without modifying the program. That is, since the functional components are configured to acquire the data by the search operation, it can be said that even without transmitting the unnecessary data when transmitting the data to the other apparatus, the configuration can be changed without modifying the program.

(8) The setting information data group 141a includes, in the field of the search formula 306, a conditional formula for selecting a target to be output to the vehicle control apparatus 2b from the object data to be output. The data management unit 12a extracts target data conforming to the search formula 306 from the output object data (S707 in FIG. 9) , and outputs the extracted target data to the vehicle control apparatus 2b (S709).

According to the present embodiment, as shown in FIG. 2, when it is necessary to transmit the data to the other apparatus, only the data entry necessary for the transmission destination can be extracted and transmitted by specifying the search formula. Therefore, in the related art, since transmission setting is performed for each data type, it is highly possible that the unnecessary data entry is also included and transmitted. However, in the present embodiment, since only the necessary data entry can be transmitted by being specified by the search formula, the consumption of the network bandwidth and the consumption of the storage capacity that are caused by the unnecessary data transmission can be reduced.

(9) The setting information data group 141a includes the value in the field of the storage necessity 303 related to necessity of writing the object data to be output to the storage unit 40a for each of the functional components. When the writing necessity information is writing necessary, the data management unit 12a writes the object data to be output to the storage unit 40a; and when the writing necessity information is writing not necessary, the data management unit 12a does not write the object data to be output to the storage unit 40a. Therefore, the vehicle control apparatus 2a can avoid storing the unnecessary data.

(10) The data management unit 12b acquires the output object data output from the vehicle control apparatus 2a via the communication control unit 50b, and controls, based on the writing necessity information in the setting information of the functional component that outputs the object data, writing of the output object data to the storage unit 40b. For example, since the value in the field of the storage necessity 303 of the map fusion calculation unit 132 in the setting information data group 141b is “Yes”, the object data output by the map fusion calculation unit 132 and acquired via the communication control unit 50b is stored in the storage unit 40b. Therefore, the vehicle control apparatus 2a can store the data appropriately.

### (First Modification)

When receiving a setting change request from outside via the communication control unit 50, the diagnosis unit 15 may output the setting change request to the execution control unit 14. Further, the setting change request received from the outside may be added with additional information, for example, information for specifying setting to be changed.

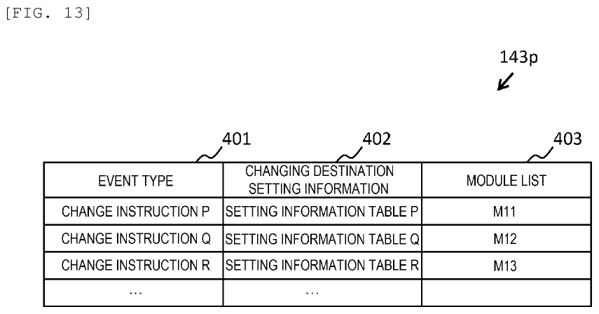

FIG. 13 is a table showing an example of a setting change data group 143p according to a first modification. According to the setting change data group 143p, a “change command P”, a “change command Q”, and a “change command R” are included in the setting change request received from the outside, and define setting information and module lists respectively corresponding to the commands.

According to the present modification, the following operational effects can be acquired in addition to the operational effects in the first embodiment described above.

(11) The events include reception of a setting change request from the vehicle control apparatus 2b. Therefore, the vehicle control apparatus 2 can change an operation in accordance with the request from the outside. Specifically, the vehicle control apparatus 2 reads an appropriate setting information table from the setting change data group 143p in accordance with the setting change request from the outside, and determines the module list to be executed thereafter.

### Second Embodiment

The first embodiment shows the vehicle system 1 that implements the fail-operational function by changing the configuration of the application between the vehicle control apparatus 2a and the vehicle control apparatus 2b. In the second embodiment, a development system of the vehicle control apparatus 2 will be described.

### (Configuration)

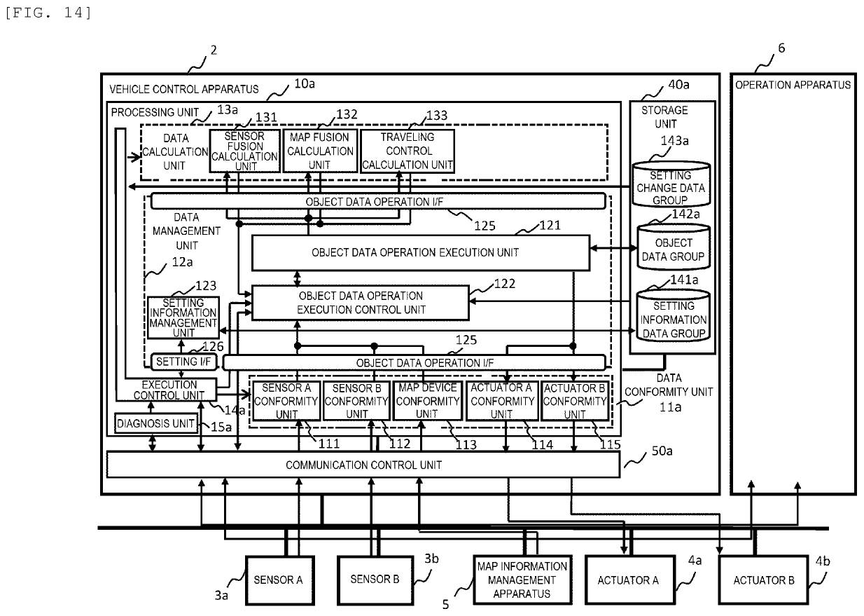

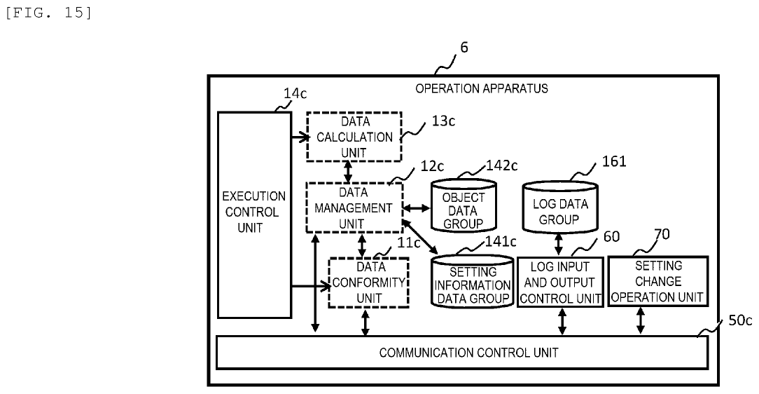

FIGS. 14 and 15 are functional block diagrams showing a configuration of a development system 1a including the vehicle control apparatus according to the second embodiment of the invention. A configuration of an operation apparatus 6 is shown in FIG. 15. The development system 1a is mounted on a vehicle and includes the operation apparatus 6 in addition to the vehicle control apparatus 2, the sensor group 3, the actuator group 4, and the map information management apparatus 5 shown in the first embodiment. Since a structure of the vehicle control apparatus 2 is the same as that of the first embodiment, a description thereof will be omitted.

The operation apparatus 6 shown in FIG. 15 is, for example, a general-purpose processing apparatus such as a personal computer, and is used for state monitoring and control of the vehicle control apparatus 2 by a developer of the vehicle control apparatus 2. The operation apparatus 6 includes a communication control unit 50c, a log input and output control unit 60, and a setting change operation unit 70. The communication control unit 50c corresponds to the communication control unit 50a of the vehicle control apparatus 2. Further, the data conformity unit 11c, the data management unit 12c, the data calculation unit 13c, and the execution control unit 14c, the setting information data group 141c and the object data group 142c correspond to the data conformity unit 11a, the data management unit 12a, the data calculation unit 13a, the execution control unit 14a, and the setting information data group 141a, and the object data group 142a of the vehicle control apparatus 2.

The log input and output control unit 60 stores an object data update operation request message output from the vehicle control apparatus 2 to a network as a log data group 161. The log input and output control unit 60 also outputs the object data update operation request message acquired from the log data group 161 to the network at a predetermined timing. The setting change operation unit 70 provides an operation interface that changes the setting information data group 141a of the vehicle control apparatus 2a via the execution control unit 14a of the vehicle control apparatus 2.

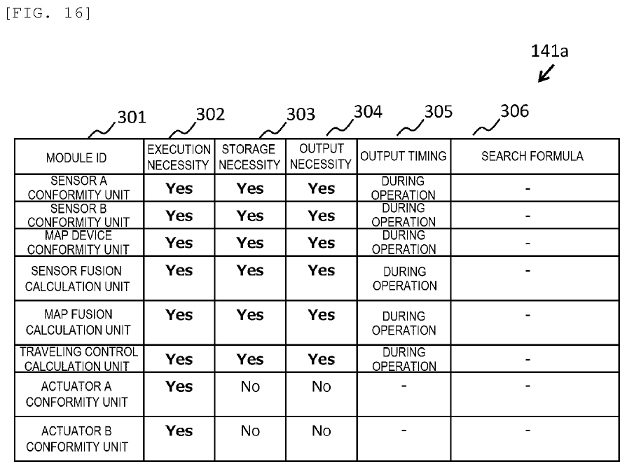

FIG. 16 is a table showing an example of the setting information data group 141a of the vehicle control apparatus 2. A difference from the setting information in the first embodiment is that, for some functional components, the value in the field of the output necessity 304 is “Yes” and the value in the field of the output timing 305 is “during operation”. For these functional components, since the value in the field of the storage necessity 303 is also “Yes”, it means that a calculation result is also output to the outside while being stored in the object data group 142a of the vehicle control apparatus 2, which corresponds to log output of a calculation result of each of the functional components. The output data (corresponding to the object data update operation request message 900 in FIG. 11) is acquired by the log input and output control unit 60 of the operation apparatus 6 and stored in the log data group 161. At this time, each log data is managed in association with output time point information.

In the setting information of FIG. 16, although all data stored in the object data group 142a is output, only a calculation result of a specific functional component can be output by adjusting setting of the output necessity 304.

### (Example of Debugging Specific Application)

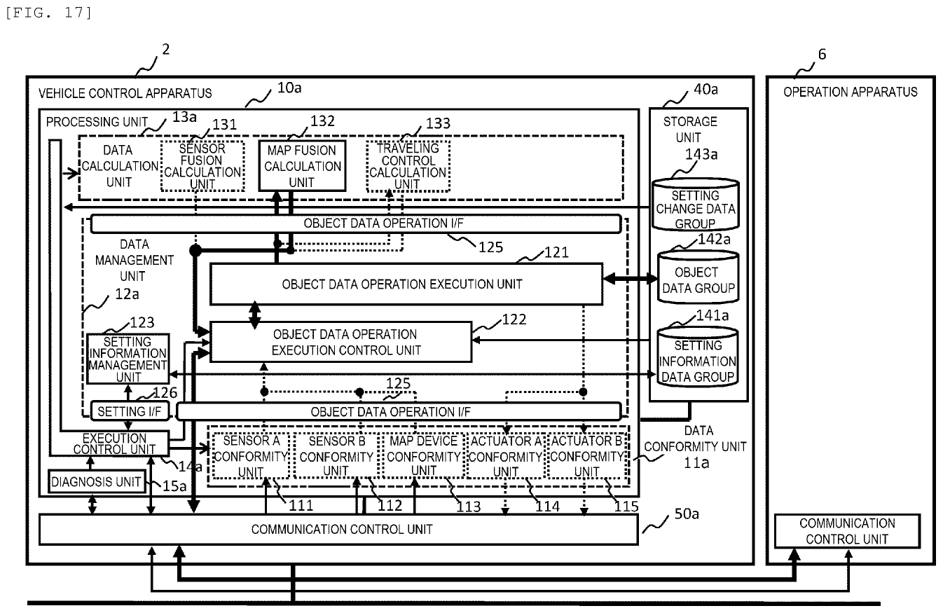

An example in which the acquired log data is reproduced to debug the specific application will be described with reference to FIGS. 17 to 19.

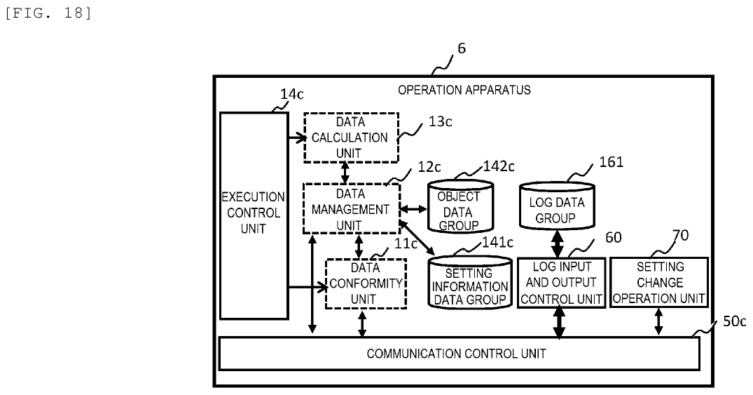

FIGS. 17 and 18 are functional block diagrams showing an example of the configuration of the system for debugging the map fusion calculation unit 132. Here, it is assumed that a malfunction of the map fusion calculation unit 132 is discovered during an operation check of the vehicle control apparatus 2 in the system configuration of FIG. 14. The log data of the calculation result of each of the functional components before and after the malfunction is stored in the log data group 161 of the operation apparatus 6. A system configuration shown in FIGS. 17 and 18 is the same as that shown in FIGS. 14 and 15, and the functional components that do not operate due to the debugging to be described below are indicated by broken lines. In FIGS. 17 and 18, paths through which the main data is distributed during the debugging are indicated by thick arrows.

In FIG. 18, the log input and output control unit 60 outputs the log data to the vehicle control apparatus 2 based on the time point information stored in association with the log data. As described above, the log data here corresponds to the object data update operation request message. Therefore, the log data is handled in the same manner as that of the data transmission of the object data operation execution control unit 122 of the vehicle control apparatus 2 and is passed to the object data operation execution control unit 122 via the object data operation interface 125, and the object data update processing shown in FIG. 9 is executed.

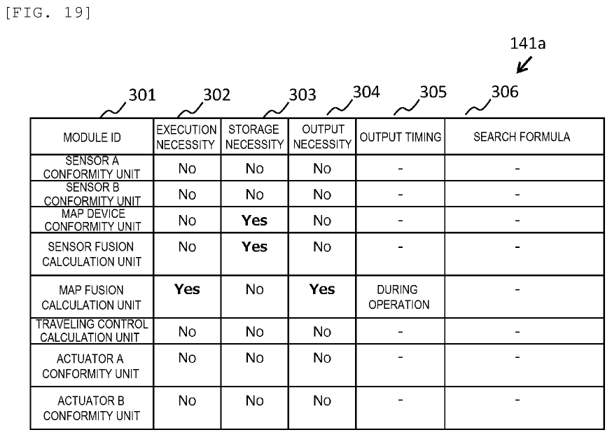

FIG. 19 is a table showing an example of the setting information data group 141a in FIG. 17. Since the configuration shown in FIG. 17 aims to debug the map fusion calculation unit 132, as shown in FIG. 19, “No” is set in the fields of the execution necessity 302 for the functional components except the map fusion calculation unit 132. Since the map fusion calculation unit 132 uses the output result of the sensor fusion calculation unit 131 and the map information provided by the map information management apparatus 5 for calculation, the output result and the map information are necessary to be used as input data. Therefore, the values in the fields of the storage necessity 303 of the map device conformity unit 113 as well as the sensor fusion calculation unit 131 are set to “Yes”.

With the above setting information, since the object data update operation of the sensor fusion calculation unit 131 and the map device conformity unit 113 reproduced and output from the log input and output control unit 60 is reflected in the object data group 142a, the map fusion calculation unit 132 performs the calculation processing based on the input data equivalent to that when the malfunction is generated. Therefore, the malfunction can be reproduced with a high probability. Accordingly, problem analysis becomes easy, and the application can be debugged efficiently.

According to the present embodiment, a system environment construction, which is for debugging a predetermined application by the log output and the log reproduction of the calculation result output of the functional component, can be implemented without modifying a program by appropriately changing the setting information from the operation apparatus.

The embodiment described above is an example, and the invention is not limited thereto. That is, various applications are possible and all embodiments are within the scope of the invention.

For example, in the above embodiment, in the vehicle control apparatus 2, each processing is assumed to be executed by the same processing unit and the same storage unit, but may be executed by a plurality of different processing units and a plurality of different storage units. In this case, for example, the processing is executed by installing processing software having the same configuration in the respective storage units and sharing the processing with the respective processing units.

Further, each processing of the vehicle control apparatus 2 is implemented by executing a predetermined operation program by using a processor and a RAM, but may also be implemented by dedicated hardware as necessary. Further, although the vehicle control apparatus, the sensor group, the map information management apparatus, and the actuator group are described as individual devices in the above embodiment, any two or more of the devices may be combined and implemented as necessary.

Further, in the drawings, control lines and information lines necessary for describing the embodiments are shown, but not all the control lines and information lines included in an actual product to which the invention is applied are necessarily shown. In practice, it may be considered that almost all the configurations are connected to each other.

A disclosed content of the following priority basic application is incorporated herein by reference.

Japanese Patent Application No. 2017-143738 (filed on Jul. 25, 2017)

### REFERENCE SIGN LIST

1 vehicle system
2 vehicle control apparatus
3 sensor group
3a sensor A
3b sensor B
4 actuator group
4a actuator A
4b actuator B
5 map information management apparatus
10 processing unit
11 data conformity unit
12 data management unit
13 data calculation unit
14 execution control unit
15 diagnosis unit
40 storage unit
50 communication control unit
111 sensor A conformity unit
112 sensor B conformity unit
113 map device conformity unit
114 actuator A conformity unit, actuator B conformity unit
121 object data operation execution unit
122 object data operation execution control unit
123 setting information management unit
125 object data operation interface
126 setting interface
131 sensor fusion calculation unit
132 map fusion calculation unit
133 traveling control calculation unit

1. A vehicle control apparatus configured to be communicably connected to an external apparatus, the vehicle control apparatus comprising:
a communication control unit configured to control data transmission to and reception from the external apparatus;
a data management unit configured to manage object data;
one or more functional components configured to perform a predetermined calculation by using object data acquired from the data management unit or the communication control unit, and to output output object data which is object data acquired by the predetermined calculation to the data management unit; and
a storage unit configured to store setting information in which information on a writing destination of the output object data is stored for each of the functional components and to store object data, wherein
the data management unit is configured to control the writing destination of the output object data based on the setting information.

2. The vehicle control apparatus according to claim 1, wherein
the setting information includes external output necessity information related to necessity of outputting the output object data to the external apparatus for each of the functional components, and wherein
the data management unit is configured to output the output object data to the external apparatus via the communication control unit when the external output necessity information is output necessary.

3. The vehicle control apparatus according to claim 2, further comprising:
a calculation execution control unit configured to control execution of the functional components, wherein
the setting information further includes execution necessity information related to necessity of executing the functional components, and wherein
the calculation execution control unit is configured to execute the predetermined calculation of one of the functional components when the execution necessity information is execution necessary.

4. The vehicle control apparatus according to claim 3, wherein
the storage unit is configured to store a plurality of pieces of setting information respectively corresponding to a plurality of events, and wherein
the data management unit and the calculation execution control unit are configured to, when any of the plurality of events is detected, operate based on one of the pieces of setting information corresponding to a detected event.

5. The vehicle control apparatus according to claim 4, wherein
the storage unit is further configured to store a setting change information table in which an event and one of the pieces of setting information to be applied when the event is detected are associated with each other, and wherein
the data management unit and the calculation execution control unit are configured to, when any of the plurality of events is detected, specify the one of the pieces of setting information to be applied with reference to the setting change information table, and to operate based on the specified setting information.

6. The vehicle control apparatus according to claim 4, wherein
the events include a first functional component malfunction event that is a malfunction of a first functional component that is a functional component operating in the external apparatus, and wherein
the setting information corresponding to the first functional component malfunction event includes that execution of the first functional component is necessary.

7. The vehicle control apparatus according to claim 4, wherein
the events include reception of a setting change request from the external apparatus.

8. The vehicle control apparatus according to claim 3, wherein
the setting information includes, for each of the functional components, a conditional formula for reading a target to be output to the external apparatus from the object data managed by the data management unit, and wherein
the calculation execution control unit is configured to, when the conditional formula is included in the setting information for the functional component that has executed the predetermined calculation, read the object data conforming to the conditional formula from the object data managed by the data management unit, and to output the read object data to the external apparatus.

9. The vehicle control apparatus according to claim 2, wherein
the setting information includes a conditional formula for selecting a target to be output to the external apparatus from the output object data, and wherein
the data management unit is configured to extract target data conforming to the conditional formula from the output object data, and to output the extracted target data to the external apparatus.

10. The vehicle control apparatus according to claim 2, wherein
the setting information includes writing necessity information related to necessity of writing the output object data to the storage unit for each of the functional components, and wherein
the data management unit is configured to write the output object data to the storage unit when the writing necessity information is writing necessary, and not to write the output object data to the storage unit when the writing necessity information is writing not necessary.

11. The vehicle control apparatus according to claim 10, wherein
the data management unit is configured to acquire the output object data output from the external apparatus via the communication control unit, and to control, based on the writing necessity information in the setting information of the functional component that outputs the output object data, execution of writing the output object data to the storage unit.
